(19) United States
(12) Patent Application Publication
(10) Pub. No.: US 2007/0097346 A1
(43) Pub. Date: May 3, 2007

(54) Lithographic apparatus and device manufacturing method

(75) Inventors: Koen Jacobus Johannes Maria Zaal, Eindhoven (NL); Joost Jeroen Ottens, Veldhoven (NL); Jeroen Van Den Akker, Goirle (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/581,059

(22) Filed: Oct. 16, 2006

Related U.S. Application Data
(60) Provisional application No. 60/730,885, filed on Oct. 28, 2005.

(51) Int. Cl. G03B 27/58

(52) U.S. Cl. 355/72; 355/75

(57) ABSTRACT

An article support configured to support an article to be placed in a beam path of a radiation beam of a lithographic apparatus on the article support is disclosed, the article support having a base plate of a first material and a plurality of burls of a second material, bonded to the base plate of the first material.

This non-provisional application claims the benefit of and priority to U.S. Provisional Application No. 60/730,885, filed Oct. 28, 2005, the entire contents of which application is hereby incorporated by reference.

### 1. FIELD

The present invention relates to a lithographic apparatus and a method for manufacturing a device. Specifically, the invention relates to a lithographic apparatus comprising an article support configured to support an article to be placed in a beam path of radiation of the lithographic apparatus and to a method for manufacturing thin laminated structures, in particular, a method for manufacturing an article support for a lithographic apparatus.

### 2. BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning structure, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning” -direction) while synchronously scanning the substrate parallel or anti-parallel to this direction. It is also possible to transfer the pattern from the patterning structure to the substrate by imprinting the pattern onto the substrate.

In the lithographic apparatus as hereabove specified, an article to be placed in the radiation beam is held to an article support, for example, by a clamping electrode, by vacuum suction or otherwise. Electrostatic clamping may be used for example when a substrate is processed in vacuum conditions. This type of processing occurs for instance when the type of irradiation used for photolithographic processes is in the (soft) x-ray region, also referred to as the extreme ultraviolet (EUV) region.

Currently, article supports are typically from a variety of rigid materials, for instance a material known in the art as ULE, Zerodur, Cordierite or Sapphire material, or other rigid materials, such as ceramic materials or crystalline materials. These materials are chosen among others for good mechanical stability and heat conductivity and reduced thermal expansion properties.

Typically, for these materials, a number of mechanical and material properties are considered important, and where typically one material has a better mechanical stability, it may have relatively less favorable thermal expansion properties compared to another material. In particular, the Cordierite, Zerodur and ULE materials, hereinafter also indicated as materials of a first group, have good thermal characteristics in that they have a coefficient of thermal expansion (CTE) of practically zero. This makes these materials attractive for use as substrate table materials, since (local) heating of these materials does not give rise to significant distortions, which can result in a deteriorated focus and/or overlay of the images projected on a target portion of a substrate. However, the wear characteristics of these materials are such that the economic lifetime of article support made from those materials is significantly limited in comparison with other materials that are known, such as SiSiC or SiC, hereinafter indicated as materials of a second group, but which possess less favorable thermal characteristics. However, combining a layer of the first material with a layer of a second material is not straightforward since it could give rise to bimetal-like bending effects when subject to temperature variations.

Hence, a desire arises to provide a material and/or article support that combines the best of these characteristics in one.

In the context of this application, the “article” may be any of a substrate (e.g., a wafer), a patterning structure (e.g., a reticle or mask), or any other article (e.g., optical element) that is held in the radiation path of a radiation system, and more specifically may be a substrate to be processed in manufacturing devices employing lithographic projection techniques and/or a lithographic projection mask or mask blank for use in a lithographic projection apparatus, a mask handling apparatus such as mask inspection or cleaning apparatus, or a mask manufacturing apparatus.

### 3. SUMMARY

In an aspect, it is desirable to provide an article support that is more robust and less sensitive to temperature during the manufacturing process thereof. In another aspect, it is desirable to provide an article support that has an improved wear resistance.

According to an aspect of the invention, there is provided an article support configured to support an article to be placed in a beam path of a radiation beam of a lithographic apparatus on the article support, the article support comprising a base plate of a first material, and a plurality of burls of a second material, bonded to the base plate of the first material. According to an aspect, a lithographic apparatus is provided comprising the foregoing article support.

In another aspect of the invention there is provided a method of manufacturing an article support, comprising bonding a flat top surface of a burl plate to a base plate having a flat surface, the burl plate comprising a plate having a plurality of burls formed to provide the flat top surface, and removing the plate of the burl plate to leave the burls of the burl plate bonded to the base plate.

### 4. BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention; and

FIG. 2 shows schematically an article support and the steps for manufacturing the article support according to an embodiment of the invention.

### 5. DETAILED DESCRIPTION

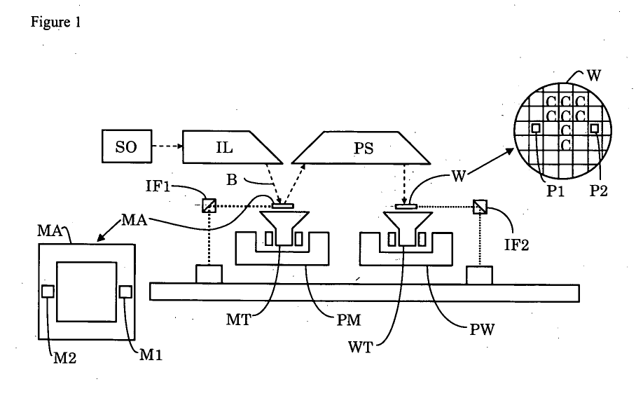

FIG. 1 schematically depicts a lithographic apparatus according to one embodiment of the invention. The apparatus comprises:

an illumination system (illuminator) IL configured to condition a radiation beam B (e.g. UV radiation or EUV radiation);

a support structure (e.g. a mask table) MT constructed to support a patterning structure (e.g. a mask) MA and connected to a first positioner PM configured to accurately position the patterning structure in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning structure MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure holds the patterning structure in a manner that depends on the orientation of the patterning structure, the design of the lithographic apparatus, and other conditions, such as for example whether or not the patterning structure is held in a vacuum environment. The support structure can use mechanical, vacuum, electrostatic or other clamping techniques to hold the patterning structure. The support structure may be a frame or a table, for example, which may be fixed or movable as required. The support structure may ensure that the patterning structure is at a desired position, for example with respect to the projection system. Any use of the terms “reticle” or “mask” herein may be considered synonymous with the more general term “patterning structure.”

The term “patterning structure” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning structure may be transmissive or reflective. Examples of patterning structures include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a reflective type (e.g. employing a reflective mask). Alternatively, the apparatus may be of a transmissive type (e.g. employing a transmissive mask).

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning structure (e.g., mask) MA, which is held on the support structure (e.g., mask table) MT, and is patterned by the patterning structure. Having traversed the patterning structure MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the patterning structure MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning structure MA and substrate W may be aligned using patterning structure alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning structure MA, the patterning structure alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning structure, and the substrate table WT is moved or scanned while a pattern imparted to the radiation beam is projected onto a target portion C. In this mode, generally a pulsed radiation source is employed and the programmable patterning structure is updated as required after each movement of the substrate table WT or in between successive radiation pulses during a scan. This mode of operation can be readily applied to maskless lithography that utilizes programmable patterning structure, such as a programmable mirror array of a type as referred to above.

Combinations and/or variations on the above described modes of use or entirely different modes of use may also be employed.

Designing article supports such as substrate tables or mask supports in a lithographic system can be a very critical process. In the following description, the embodiments will be referred to as substrate tables, although it should be understood that these embodiments may also be referred to or considered as the more general indication of “article support”. Specifically, in the context of an embodiment of this invention, the article supports may form any support configured to hold an article in a beam of radiation, be it a substrate, a mask or a fiducial reticle.

Conventionally, a substrate table is provided with protrusions that are arranged to improve the flatness of the substrate. A conventional substrate table is described in, for example, European patent application EP 0947884, which is incorporated herein in its entirety by reference. On the substrate table, protrusions are arranged to improve the flatness of the substrate. These protrusions have a general diameter of 0.5 mm and are located generally at a distance of 3 mm away from each other so as to form a bed of support members that support the substrate. For an electrostatic clamp as illustrated, typically, the height of the protrusions lies in the range of 1 μm to 15 μm. In other arrangements, the substrate table may provide clamping by providing a vacuum pressure on the backside of an article (known as vacuum clamping). For this type of article support, these protrusions generally have a height of around 100 μm. Due to the relatively large spaces between the protrusions, contamination that is possibly present does not generally form an obstruction to the flatness of the substrate, since the contamination typically will lie between the protrusions and will not lift the substrate locally.

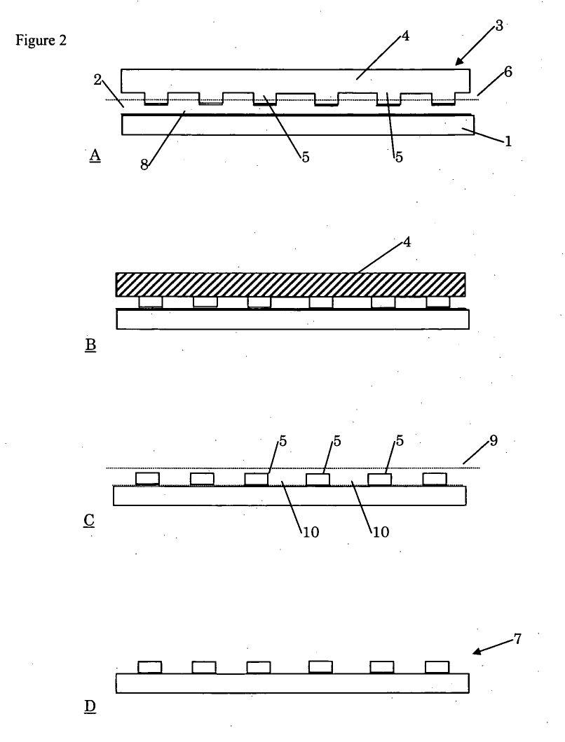

FIG. 2 illustrates schematically the article support and the actions for manufacturing the article support according to an embodiment of the invention. Specifically, referring to FIG. 2A, there is provided a base plate 1 having a flat top surface 2 and a burl plate 3 comprising a plate 4 having a plurality of burls 5 formed to provide a flat top surface 6. Referring to FIG. 2B, the flat top surface of the burl plate 3 is bonded to the base plate 1. Referring to FIG. 2C, the plate 4 of the burl plate 3 is removed thus leaving the burls 5 of the burl plate 3 bonded to the base plate 1 (see FIGS. 2C and 2D) to provide an article support 7. In particular, the article support 7 thus configured is able to support an article to be placed in a beam path of a radiation beam of a lithographic apparatus on the article support 7 and comprises a base plate 1 of a first material, and a plurality of burls 5 of a second material, bonded to the base plate of the first material.

Although in the description, the actions are indicated in consecutive order it will be understood that some of the actions may be carried out in parallel or in reverse order.

In particular, the bonding is carried out in a way that the stresses are kept within acceptable limits when joining the base plate 1 and the burl plate 3, and can be provided by a bonding layer 8 which can be applied on one or both of the facing sides the base plate 1 and burl plate 3.

By removing the plate 4 at a high temperature, for instance, substantially the same temperature where the bonding is carried out, stresses may be kept low. Otherwise, stress zones may be formed in the burl plate 3. In another aspect, the bonding temperature may be kept as low as possible, for instance, by providing local thermal energy to the bonding spots, i.e. local spot welding and/or anodic bonding. This could be done by providing an electric current through the burls 5. In an embodiment, when the article support 7 is to be use in wet environments, for instance, for immersion lithographic purposes, the bonds may be corrosion resistant. Such bonds could be obtained, for instance, by glass fritting, which can be done by providing glass powder between the base plate 1 and burl plate 3 and heating it to a glass powder melting temperature.

FIG. 2B illustrates that the plate 4 is to be removed from the burls 5 by indicating the plate as a hatched area. This can be done, depending on the materials, by a variety of techniques such as electro discharge machining, cutting, sanding, grinding or etching the plate to a desired extent. In this way, the burls 5, thus bonded to the base plate 1, are freed from their base plate and are provided as a flat top surface 9.

FIG. 2C shows that the remaining bonding layer is removed in the areas 10 between the burls 5. This may be beneficial when the object support is used in a wet environment and metal zones should be shielded and reduced to a minimum.

In another aspect of the invention, the wear resistance of the base plate 1 itself may be improved, potentially, in combination with burls 5 provided in the base plate, as is conventionally done, as considered in contrast to the hereabove described invention. In such aspect, the previous described materials of the first group are substantially non-expanding materials, for example, having a coefficient of thermal expansion of less than or equal to 0.05*E-6 K^{-l}, in particular, these materials may comprise Zerodur, ULE and/or Cordierite, and the previous described materials of the second group are materials having a fracture toughness (KIC) of more than or equal to 1.5 MPa m^{l/2}, in particular, these materials may comprise SiSiC and/or SiC.

For that matter, the materials having a practically zero CTE have less ideal fracture toughness (K_{IC}) of about 0.9-1.3, compared to a fracture toughness of 2.9 for SiSiC. Hence, the fracture toughness of Cordierite may be increased by doping it with LiNbO₃ or ZrO₂ in a volume fraction of at least 2% or generally with doping elements increasing the fracture toughness to at least a value of 1.5 MPa m^{1/2}. Improving Cordierite material characteristics is discussed in previous publications, for instance Japanese patent application no. 2000-375546.

Cordierite can be expressed by general formula of 2 MgO.2Al₂O₃.5SiO₂. The fracture toughness can then be increased to a value ranging above 2.0 MPa m^{1/2}, which gives the material an expected lifetime of about the same as the materials of the second group indicated hereabove.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning structure defines the pattern created on a substrate. The topography of the patterning structure may be pressed into a layer of resist supplied to the substrate whereupon the resist is cured by applying electromagnetic radiation, heat, pressure or a combination thereof. The patterning structure is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. An article support configured to support an article to be placed in a beam path of a radiation beam of a lithographic apparatus on the article support, the article support comprising:
a base plate of a first material; and
a plurality of burls of a second material, bonded to the base plate of the first material.

2. The support of claim 1, wherein the first material is a substantially non-expanding material and the second material is a wear resistant material.

3. The support of claim 1, wherein the first material is one of a first group of materials having a coefficient of thermal expansion of less than or equal to 0.05*E-6 K⁻¹, and wherein the second material is one of a second group of materials having a fracture toughness (K_{IC}) of more than or equal to 1.5 MPa m^{1/2}.

4. The support of claim 3, wherein the first group comprises Zerodur, ULE and Cordierite, and wherein the second group comprises SiSiC and SiC.

5. The support of claim 1, wherein the burls are bonded to the base plate via a bonding layer.

6. The support of claim 5, wherein the bonding layer is corrosion resistant.

7. The support of claim 5, wherein the bonding layer comprises a metal layer used for spot welding, anodic bonding, or both the burls.

8. A method of manufacturing an article support, comprising:
bonding a flat top surface of a burl plate to a base plate having a flat surface, the burl plate comprising a plate having a plurality of burls formed to provide the flat top surface; and
removing the plate of the burl plate to leave the burls of the burl plate bonded to the base plate.

9. The method of claim 8, wherein the bonding is provided by glass fritting.

10. The method of claim 8, wherein the bonding is provided by spot welding the burl plate using a metal coating on the base plate as a bonding layer.

11. The method of claim 9, wherein the metal layer is removed after spot welding the burls.

12. The method of claim 8, wherein the base plate is made of a substantially non-expanding material and the plurality of burls are made of a wear resistant material.

13. The method of claim 8, wherein the base plate is made of one of a first group of materials having a coefficient of thermal expansion of less than or equal to 0.05*E-6 K⁻¹, and wherein the plurality of burls are made of one of a second group of materials having a fracture toughness (K_{IC}) of more than or equal to 1.5 MPa m^{1/2}.

14. The method of claim 13, wherein the first group comprises Zerodur, ULE and Cordierite, and wherein the second group comprises SiSiC and SiC.

15. A method of increasing a fracture toughness of Cordierite comprising doping Cordierite with LiNbO₃, ZrO₂, or both.

16. A wear resistant piece of Cordierite having fracture toughness of more than or equal to 1.5 MPa m^{1/2} and comprising a fraction of LiNbO₃, ZrO₂, or both.

17. The wear resistant piece of claim 16, wherein the volume fraction of LiNbO₃, ZrO₂, or both is at least 2%.
